(19) United States
(12) Patent Application Publication
(10) Pub. No.: US 2018/0049853 A1
(43) Pub. Date: Feb. 22, 2018

(54) ULTRASONIC SCALER WITH LASER THERAPY CAPABILITY

(71) Applicants: The Regents of The University of California, Oakland, CA (US); The Arizona Board of Regents on Behalf of The University of Arizona, Tucson, AZ (US)

(72) Inventors: Rongguang Liang, Tucson, AZ (US); Petra Wilder-Smith, San Juan Capistrano, CA (US); Cherie Wink, Yorba Linda, CA (US)

(21) Appl. No.: 15/802,915

(22) Filed: Nov. 3, 2017

Related U.S. Application Data
(63) Continuation of application No. PCT/US2016/031071, filed on May 5, 2016.
(60) Provisional application No. 62/157,452, filed on May 5, 2015.

(51) Int. Cl. A61C 17/20; A61C 1/00; A61C 3/03; A61C 1/08

(52) U.S. Cl. CPC A61C 17/20; A61C 1/0046; A61C 1/08; A61C 1/0023; A61C 3/03

(57) ABSTRACT

An ultrasonic device with laser therapy capability, and more particularly, but not exclusively, to ultrasonic scaler with laser therapy capability.

### FIELD OF THE INVENTIONS

The present inventions relate generally to dental scalers with light therapy functionality such as ultrasonic scaler devices with laser bacterial load reduction capability.

### BACKGROUND OF THE INVENTIONS

Currently, nonsurgical periodontal therapy, including scaling and root planning, as well as periodontal scaling with root debridement involves a series of instrumentation procedures. Aerosol produced during the use of power scalers has droplet nuclei particles which linger in the environment for extended periods of time, and is a potential source of infection to patients as well as oral health care providers. The release of an increased bacterial load into the oral cavity may result in the spread of periodontal and oral pathogens.

Laser Bacterial Reduction (LBR) can be performed prior to procedures such as scaling to prevent the spread of periodontal pathogenic bacteria from a diseased site within the oral cavity to one of health. Clinicians will then proceed to use a power scaler, such as an Ultrasonic or Piezoelectric scaler, to remove the larger, calcified deposits while simultaneously disrupting the plaque biofilm. The more intricate work of scaling and root planning, utilizing a series of manual curettes, then follows. Once all visible and tactile deposits have been removed, the clinician may choose to utilize the laser again to perform soft tissue curettage of the tissues.

Scaling and root planning, also known as conventional periodontal therapy, non-surgical periodontal therapy, or deep cleaning, is the process of removing or eliminating the etiologic agents, dental plaque, its products, and calculus. Periodontal scalers and periodontal curettes are used for such procedures.

An ultrasonic scaler is a tool which utilizes various tips for supplying high-frequency vibrations to the tooth surfaces for the purpose of removal of adherent deposits and bits of inflamed tissue from the inner walls of the gingival sulcus or periodontal pocket. Mechanical root debridement results in a smear layer containing bacteria, bacterial endotoxins, and contaminated root cementum and usually does not remove plaque and calculus completely from interradicular septa and root concavities. A significant disadvantage of ultrasonic scalers, for the patient and the clinician, is the formation of a contaminated aerosol.

In recent years, the use of lasers in dentistry has continued to expand. Dental laser systems are cleared for marketing in the United States via the Food and Drug Administration (FDA) Premarket Notification (510(k)) process. The applications of lasers in dentistry include sulcular debridement, laser curettage, laser-assisted new attachment procedure (LANAP), reduction of bacteria levels in periodontal pockets (or pocket sterilization) referred to as laser bacterial reduction (LBR), laser-facilitated wound healing, and laser root planning. For example, erbium-doped: yttrium, aluminum, and garnet (Er:YAG) laser radiation has been suggested as an alternative instrumentation modality for the treatment of chronic periodontitis. Dental hygienists use lasers for laser bacterial reduction, laser curettage, intrasulcular debridement in scaling and root planning procedures, aphthous ulcer removal, and pit and fissure sealants. Periodontists use lasers for osseous surgery and to correct osseous defects, gingivectomies, frenectomies, gingival curettage, implant placement, and soft tissue crown lengthening.

Currently, periodontal probes, ultrasonic scalers, curettes, and dental lasers, each have their own application and working tip. Dental professionals measure the sulcus or periodontal pocket prior to instrumentation utilizing a periodontal probe to assess the geography. Prior to any instrumentation, the clinician may perform laser bacterial reduction. Next, an ultrasonic scaler can be used, followed by the use of curettes, to remove deposits from the tooth surfaces. Dental lasers can then be used again to remove the remaining soft tissue tags, continue reduction of bacterial levels, and possibly promote wound healing.

Time is taken away from patient care each time the clinician has to change instruments and switch back and forth between the periodontal probe, ultrasonic scaler, curette, and laser. Thus there remains a need in the art for a new device that combines these individual steps while promoting a potential healthier environment, and reducing the risk of disease transfer, both inside and outside of the oral cavity.

### SUMMARY OF THE INVENTIONS

An aspect of at least one of the inventions disclosed herein, includes the realization that a dental scaler tip assembly can be modified to include a passage allowing light to travel through the scaler tip assembly through the distal end of the tip assembly in the vicinity of operational end of the scaler tip assembly which can be pressed against deposits along patient's anatomy, such as on a patient's teeth and/or gums. For example, a dental scaler tip assembly can include a channel with an input opening configured to receive light from a light source, such as a laser light source, and an output opening on a distal portion of the tip assembly. The output opening can be disposed in the vicinity or at the distal-most portion of the scaler tip assembly. Thus, during use, light having an optical strength sufficient for bacteria load reduction can be directed towards deposits to be removed with the scaler during a procedure and thus treated with the bacteria load reducing light during scaling, or other procedures. Thus, the bacteria load can be reduced at the point of and simultaneous with the use of the scaler tip assembly.

Another aspect of at least one of the inventions disclosed herein includes the realization that using prior art techniques, such as the use of a separate laser bacteria load reducing technique prior to scaling is that such laser based bacteria load reducing techniques are limited in the depth to which the bacteria load is reduced at the deposit or anatomy. Thus, if a first bacteria load reducing technique is applied to a patient, then a scaling operation is performed, additional untreated bacteria can be uncovered during the course of the scaling procedure, thereby increasing the risk of aerosolizing untreated bacteria after having been uncovered during a scaling procedure.

Thus, an aspect of at least one of the inventions disclosed herein includes the realization that including a light discharge functionality with a scaler tip assembly provides the additional benefit of the ability to reduce the bacterial load of untreated bacteria contemporaneously uncovered during a scaling procedure.

In some embodiments, an ultrasonic scaler guides laser light to the tip of the scaler. As noted above, in some known prior art ultrasonic scalers, the traditional ultrasonic insert has only one function, which is to remove hard and soft deposits along with extrinsic stain, it does not contain a laser light.

Thus, in some embodiments, a scaler device can include an insert configured to guide laser light from a handheld portion to the tip of the scaler through a hollow canal. Thus, only one device is needed for the utilization of the ultrasonic scaler and dental laser. Such a device can reduce a procedure time significantly and also reduce the cost.

In some embodiments, ultrasonic insert can also guide the water to the tip of the scaler through a hollow canal.

In some embodiments, a tip of an ultrasonic scaler can be color coded, similar to that of a periodontal probe, to allow for measurement and reference as it is used. Additionally, a plurality of ultrasonic scaler tips having different sizes and color coded according to their different sizes can be packaged together in a kit.

Infection control is a constant and critical part of all dental hygiene procedures. Because ultrasonics can generate a significant amount of aerosol and splatter due the rapid vibration and water spray, use of the high speed evacuation is recommended by the Occupational Health and Safety Administration (OSHA). Without an assistant, many clinicians find themselves unable to adapt the high speed evacuation to where they are working with one hand, so frequently, they will settle for use of the slow speed suction because of its ease of use, despite the current recommendations. Ultimately, dental clinicians are exposing themselves and their patients to potentially pathogenic aerosol. Thus a device that combines ultrasonic scaling functionality and laser bacteria load reduction can reduce the number of pathogenic microbes from becoming airborne and potential reduce the amount of cross-contamination within the mouth as the instrument is taken from site to site

In some embodiments, an ultrasonic scaler can be configured to work with different laser sources. In such configurations, additional components can be unnecessary to accommodate different laser sources.

Another aspect of at least one of the inventions disclosed herein includes the realization that dental procedures, such as scaling, can be combined with measurement. For example, procedures such as scaling involve a practitioner moving a scaler device carefully over the surface of patient anatomy, and optionally using magnification to assist in visualizing the procedural field. The procedure such as scaling is also procedurally similar to probing, for example, inspecting patient's anatomy for defects and the measurements of the size of such defects. During the movements commonly used in scaling procedures, a practitioner can move the tip of a scaler assembly into close proximity and/or contact with a defect.

An aspect of at least one of the inventions disclosed herein includes the realization that dental scaler tip assemblies can be modified to simplify a process for measurement and/or estimation of measurements of dental defects, for example, with reference indicia. For example, a dental scaler tip assembly with reference indicia (such as color coding) can provide a reminder to a practitioner as to a dimension of a portion of the dental scaler tip assembly. For example, in some embodiments, a referenced dimension would be a maximum width of a distal tip of a dental scaler tip assembly.

Thus, during a procedure such as a scaling procedure, as a practitioner moves the dental scaler tip assembly around the patient's anatomy, the practitioner can estimate the size of anatomical features and/or defects with visual reference to the referenced dimension of the dental tip assembly.

Another aspect of at least one of the inventions disclosed herein includes the realization that if a plurality of dental scaler tip assemblies are packaged together in a kit having a predetermined distribution of sizes of a referenced dimension, such as the largest width of a distal tip of such scaler tip assemblies, a practitioner can more easily measure or estimate a size of anatomical features and/or defects of patient anatomy during use. For example, a dental scaler tip kit can include a plurality of differently sized dental scaler tip assemblies, which can be color coded, so that a practitioner can readily identify a size of the referenced dimension of the scaler tip assembly to further simplify a process for measuring or estimating a dimension of an anatomical structure or defect.

In some embodiments, a dental scaler system can comprise an ultrasonic driver having an ultrasonic vibration signal output port, the ultrasonic driver configured to discharge an ultrasonic frequency vibration signal from the ultrasonic vibration signal output port. A laser light source can have a laser light output port; the laser light source configured to discharge laser light from the laser light output port. A hand-piece housing can have an outer surface configured to be graspable and manipulable with a user's hand, the hand-piece housing having an input assembly connected to the ultrasonic vibration signal output port so as to receive an ultrasonic vibration signal from the ultrasonic driver, the input assembly also connected to the laser light output port so as to receive laser light from the laser light source, the hand-piece also comprising a output assembly configured to output an ultrasonic vibration and laser light. An ultrasonic scaler member can have a proximal end and a distal end, the proximal end of the ultrasonic scaler member can be connected to the output assembly of the handpiece housing, the ultrasonic scaler member comprising a light guide extending from a light guide input at the proximal end of the ultrasonic scaler member to a light guide output at the distal end of the ultrasonic scaler member, the light guide output configured to discharge laser light from the distal end of the ultrasonic scaler member.

In some embodiments, the light guide is configured to receive laser light having a wavelength in the range of 0.4 μm to 3.0 μm.

In some embodiments, the light guide comprises a hollow passage extending from the proximal end of the ultrasonic scaler member to the distal end of the ultrasonic scaler member, the light guide comprising an inner surface with high reflectivity.

In some embodiments, the handpiece housing comprises a light coupling including a reflector, connecting the input assembly with the output assembly.

In some embodiments, the light coupling comprises a fiber coupler.

In some embodiments, the ultrasonic scaler member includes a concave portion, and water outlet port being disposed in the concave portion.

In some embodiments, the ultrasonic scaler member comprises a canal extending from the proximal end to the distal end of the ultrasonic scaler member, the canal configured to guide water from the proximal end to the distal end.

In some embodiments, a dental scaler can comprise a hand-piece housing having an outer surface configured to be graspable and manipulable with a user's hand. An ultrasonic scaler member can have a proximal end and a distal end, the proximal end of the ultrasonic scaler member being connected to the hand-piece housing, the proximal end of the ultrasonic scaler member including a light input portion and a light guide extending from the light input portion to a light output portion at a distal end of the ultrasonic scaler member, the light output portion being configured to discharge laser light from the distal end of the ultrasonic scaler member.

In some embodiments, an ultrasonic transducer can be disposed in the hand-piece and in vibrational communication with the ultrasonic scaler member, the ultrasonic transducer configured to vibrate the ultrasonic scaler member at an ultrasonic frequency.

In some embodiments, an ultrasonic driver can be operationally connected to the ultrasonic scaler member and configured to transfer an ultrasonic frequency vibration signal to the ultrasonic scaler member.

In some embodiments, a laser light source can be operationally connected to the ultrasonic scaler member and configured to provide laser light to the ultrasonic scaler member.

In some embodiments, an input device can be disposed on ab outer surface of the hand-piece housing configured to control discharge of light through the ultrasonic scaler member.

In some embodiments, the light guide is configured to receive laser light having a wavelength in the range of 0.4 μm to 3.0 μm.

In some embodiments, wherein the light guide has an upstream end and a downstream end, the upstream end being larger than the downstream end.

In some embodiments, the light guide has an inner diameter that gradually changes from a larger diameter at the upstream end to a smaller diameter at the downstream end.

In some embodiments, the handpiece housing comprises a light coupling including a reflector, connecting the input assembly with the output assembly.

In some embodiments, wherein the light coupling comprises a fiber coupler.

In some embodiments, wherein the ultrasonic scaler member includes a concave portion, and water outlet port being disposed in the concave portion.

In some embodiments, wherein the ultrasonic scaler member comprises a canal extending from the proximal end to the distal end of the ultrasonic scaler member, the canal configured to guide water from the proximal end to the distal end.

In some embodiments, a dental scaler tip member can comprise a proximal end and a distal end, the proximal end of the dental scaler member being configured to be connectable to an ultrasonic scaler hand-piece housing, the proximal end of the ultrasonic scaler member including a light input portion and a light guide extending from the light input portion to a light output portion at a distal end of the ultrasonic scaler member, the light output portion being configured to discharge laser light from the distal end of the ultrasonic scaler member.

In some embodiments, the light guide has an inner surface with a reflectivity of at least 50%.

In some embodiments, the light guide is configured to guide laser light having a wavelength in the range of 0.4 μm to 3.0 μm from the proximal end to the distal end of the dental scaler tip member.

In some embodiments, the dental scaler tip member is configured to be vibrated at an ultrasonic frequency during a dental scaling procedure.

In some embodiments, a dental scaler tip kip can comprise at least first and second dental scaler tip members, each of the plurality of dental scaler tip members comprising a proximal end and a distal end, the proximal end of each dental scaler member being configured to be connectable to an ultrasonic scaler hand-piece housing, the distal end of each of the dental scaler tip members having a different dimension, each of the dental scaler tip members having a different color, and all of the plurality of dental scaler tip members being contained in a single container.

### BRIEF DESCRIPTION OF THE DRAWINGS

These and other features of the inventions disclosed herein are described below with reference to the drawings of various embodiments of dental scaler systems and components which are intended to illustrate, but not to limit, the inventions. The drawings contain the following figures:

FIG. 1 is a schematic diagram of prior art ultrasonic dental scaler.

FIG. 2 is a schematic diagram of a prior art laser curettage device.

FIG. 3A is a schematic diagram of an embodiment of a scaler system with light therapy functionality including a sonic driver unit and a light driver unit, both of which are connected to an embodiment of a scaler handheld piece and an embodiment of a dental scaling tip assembly.

FIG. 3B is a schematic illustration of a further embodiment of the dental scaler system with light therapy functionality, including an integrated sonic and light driver and an integrated connector between the driver and handheld piece.

FIG. 3C is a schematic diagram of the connections between the integrated driver, handpiece, and tip assembly of the embodiment of FIG. 3B.

FIG. 4 is a schematic diagram of a dental scaler assembly including a handheld piece, a driver connector, and a scaler tip assembly in which light is transmitted to the handheld piece, and into the scaler tip assembly, and discharged through a distal end of the scaler tip assembly.

FIG. 5 is a modification of the embodiment of FIG. 4, including a water discharge opening in a concave area of the dental tip assembly.

FIG. 6 is a schematic illustration of a further modification of the embodiments of FIGS. 4 and 5 in which an optical fiber extends through the handheld piece and the dental scaler tip assembly.

FIG. 7 is a schematic diagram of a further modification of the embodiments of FIGS. 4-6 in which a fiber is used for directing light to the handheld piece, the handheld piece and a portion of the dental scaler tip assembly includes an optical passage and a distal portion of the scaler tip assembly includes an additional fiber for directing light to a distal end of the tip assembly.

FIG. 8 is a schematic illustration of yet another modification of the embodiments of FIGS. 4-7, including a light input port on the handheld piece, separate from the connector to the driver to the sonic driver unit, and including a reflector for directing the light parallel to the water channel.

FIG. 9 is a schematic diagram of a kit including plurality of color-coded dental scaler tip members with different dimensions.

### DETAILED DESCRIPTION

Embodiments of the inventions disclosed herein are described in the context of ultrasonic dental scalers because they have particular utilities in this context. However, the inventions disclosed herein can be used in other contexts as well, such as other types of dental tools, surgical tools, and other medical devices.

In the following detailed description, terms of orientation such as “upper,” “lower,” “longitudinal,” “horizontal,” “vertical,” “lateral,” “distal”, “proximal”, “midpoint,” and “end” are used herein to simply the description in the context of the illustrated embodiments. Because other orientations are possible, however, the present inventions should not be limited to the illustrated orientations. Those skilled in the art will appreciate that other orientations of various components described herein are possible.

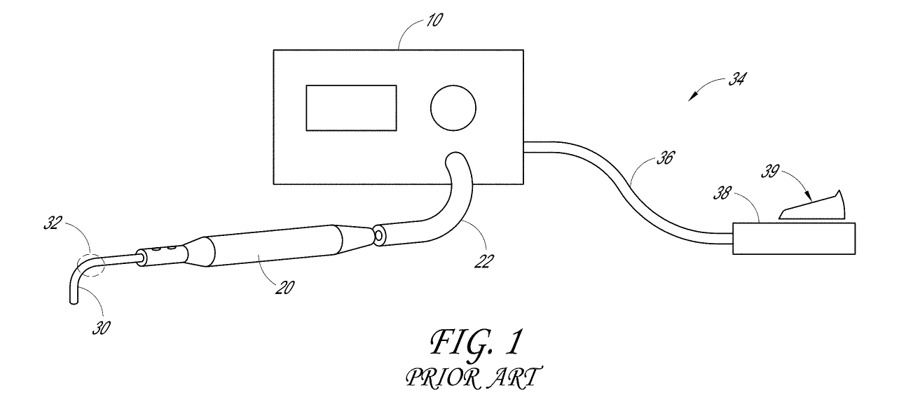

FIG. 1 schematically illustrates a prior art ultrasonic scaler. It consists of main unit 10 which can be considered as a sonic or ultrasonic driver, a handheld piece 20 and the ultrasonic tip assembly 30. Some prior art ultrasonic tip assemblies have a hollow canal to guide the water to the opening in the concave region 32 of the insert so that the water can clean the examined region. The hollow canal may or may not reach the tip of the assembly 30, therefore water may not be able to reach the tip. Such traditional assemblies 30 are not able to deliver the laser light to a tooth region.

Such prior art ultrasonic scaler systems can include a foot pedal actuator assembly 34 including a control line 36 and a foot pedal 38. In this type of configuration, the foot pedal actuator assembly 34 includes a switch (not shown) in the foot pedal assembly 38. The switch is actuatable by a moveable pedal member 39 which is pivotably mounted relative to a base of the foot pedal assembly 38. The control line 36 can include one or more electrical wires configured to cooperate with the switch within the foot pedal assembly 38 and for providing an on/off signal and/or functionality for the main unit 10. As such, the main unit 10 is configured to turn or turn off a sonic or ultrasonic signal delivered to the handheld piece 20. In some systems, ultrasonic vibrations are conducted through an air passage to the tip assembly 30. In piezoelectric systems, electrical signals are delivered to a piezo electric transducer in the handheld piece 20. Thus, during use, a user can hold the handheld piece 20 placing the ultrasonic tip assembly 30 into proximity and/or contact with a patient's anatomy and use the foot pedal control assembly 34 for turning on or turning off the delivery of ultrasonic signal to the assembly 30.

The handheld piece 20 is connected to the main unit 10 with a connector hose 22. The connector hose 22 can include an ultrasonic delivery channel (delivering ultrasonic vibrations conducted by air or in the form of electrical signals to a piezoelectric transducer, and optionally a water delivery channel. The foot pedal assembly 34 can be used to control the actuation of the ultrasonic signal to the tip assembly 30 and/or water delivery to the tip assembly 30.

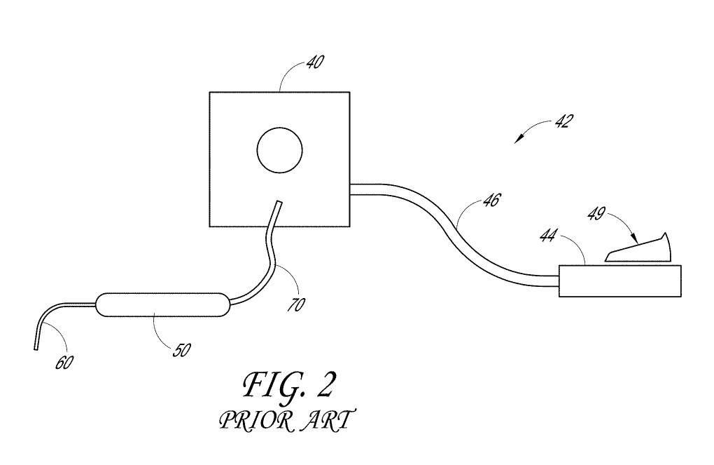

FIG. 2 is a schematic illustration of a prior art laser curettage device. The laser curettage device of FIG. 2 includes a laser driver unit 40, an optical fiber unit 70, handheld piece 50, and a fiber probe 60. Such a curettage device can be foot-pedal controlled. For example, the laser curettage prior art system can include a foot pedal assembly 42 including a foot pedal unit 44 connected to the driver 40 with a foot pedal control line 46. The foot pedal unit 44 can include a user actuatable foot pedal member 49. As such, the foot pedal control unit 42 can be used to trigger the driver 40 to turn on or turn off light energy, such as laser light energy, delivered to the fiber 70 and ultimately to the fiber 60.

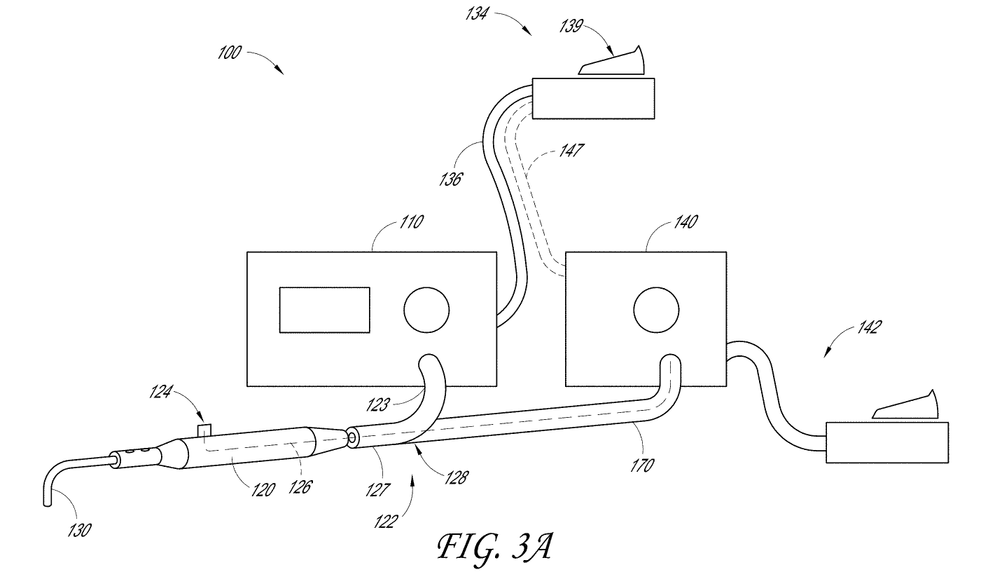

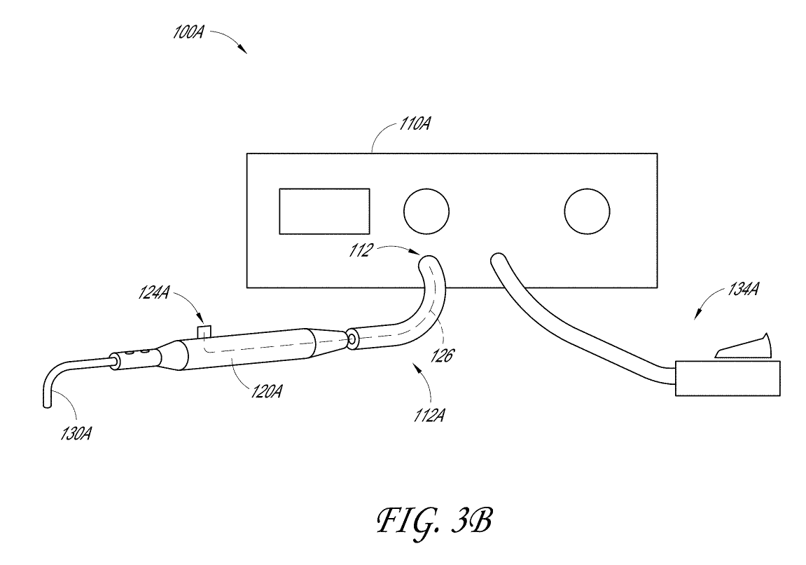

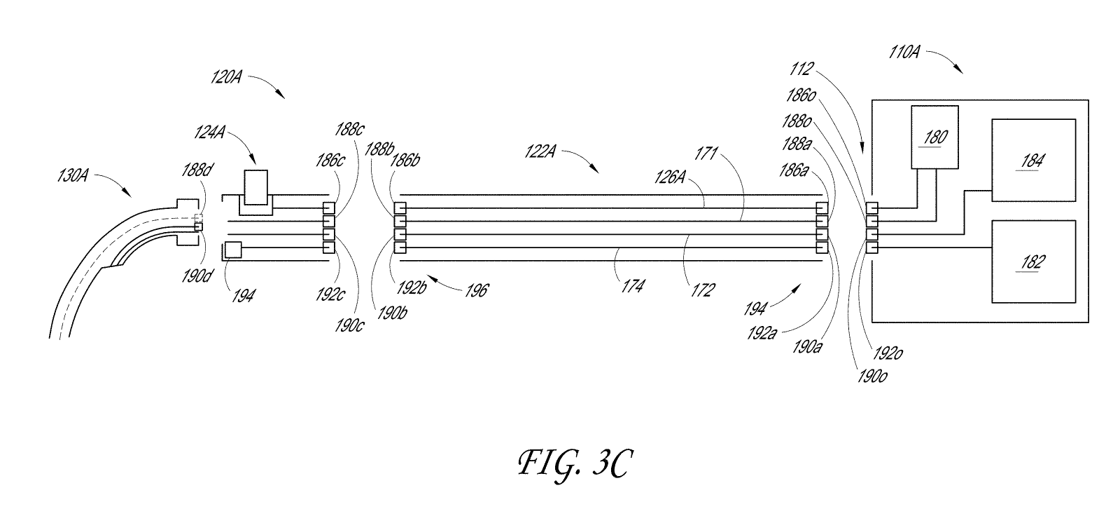

FIG. 3 illustrates an embodiment of a dental scaler with light therapy system 100 in accordance with an embodiment. Some components of the system 100 are described with the same reference numerals used for identifying portions of the systems shown in FIGS. 1 and 2 because they can have similar construction, except as described below.

As shown in FIG. 3A, the system 100 includes a driver unit 110, a light driver unit 140, a connector assembly 122, a handheld piece 120, and a scaler tip assembly 130.

The driver unit 110 can be constructed in accordance with the driver unit 10 of FIG. 1, and can include a foot pedal control assembly 134. Similarly, the light therapy driver unit 140 can be in the form of the light therapy unit 40 of FIG. 3, and can include a foot pedal control assembly 142.

Optionally, the foot pedal control assembly 134 can be connected to both the driver unit 110 with a control line 136 as well as an optional light therapy control line 147. In some embodiments, the foot pedal control assembly can include a single pedal 139 operably connected via the control lines 136, 147 to the driver units 110, 140, respectively, for turning on the sonic signal from the driver 110 and the light from the driver 140 through a single operation.

Optionally, the handheld piece 120 can include an input device 124 accessible on an outer surface of the handheld piece 120. For example, the input device 124 can be in the form of a user actuatable button, or any other type of input device. The input device 124 can be connected to the light therapy driver 140 with a control line 126 extending along and/or through the handheld piece 120 and the connector line 122, into the light therapy device 140, for performing essentially the same function as the foot pedal assembly 142.

In some configurations, the connector line 122 can be bifurcated, including a common end 127 connected to an input end of the handheld piece 120, and a bifurcated portion 128 at which location the connector line 122 is split into a sonic driver portion 123 and a light therapy connector portion 170. Other configurations can also be used.

In operation, a sonic signal from the sonic driver unit 110 can be delivered to the handheld piece 120, and then to the ultrasonic scaler tip assembly 30. Light, such as laser light, from the light therapy unit 140 can also be delivered to the handheld piece 120 through the connector portion 170, which can contain an optic fiber.

As such, ultrasonic signal and light therapy features are integrated and can be simultaneously delivered to the handheld piece 120. Thus, the system 120 can reduce potentially pathogenic microorganisms in the air, providing a safer working environment.

The ultrasonic tip assembly 130 can be configured to deliver both light and water to a desired target area, as well as ultrasonic energy. For example, the connector 122 can be configured to deliver water from the sonic driver 110, to the handpiece 120, and to the ultrasonic tip assembly 130. The system 100 can also reduce the possible transfer of periodontal pathogenic bacteria from a diseased pocket to healthy sulcus.

In some embodiments, the ultrasonic tip assembly 130 can be color coded, providing an indicia indicating a size of a referenced dimension of the tip assembly 130. Such a color coding technique can allow a clinician or practitioner to have a convenient means for measuring or estimating a measurement of an area, such as an anatomical structure or defect of a patient. For example, if an anatomical structure such as a pocket, is smaller than an ultrasonic tip assembly 130 then being used by the clinician, the clinician can find a smaller size tip, indicated by color coding of the tip, switch to a smaller size tip by installing onto the handheld piece 120, and continue the procedure.

Additionally, the system 100 can provide a further advantage in that a dental professional can use a single device to perform both scaling and root planning, remove any remaining soft tissue tags, reduce bacteria levels, and promote wound healing.

FIG. 3B illustrates a modification of the embodiment of FIG. 3A. In the embodiment of FIG. 3B, the modified embodiment is identified generally by the reference numeral 100A. Components, parts, and features, and functionality of the system 100A can be similar or the same as those of the system 100 described above and thus corresponding components have been identified with the same reference numeral, except that a letter A has been added thereto.

With reference to FIG. 3B, the system 100A can include an integrated sonic and light driver device 110A which includes the components and functionalities of both the driver 110 and the light therapy driver 140 of the system 100 described above.

Optionally, the integrated driver 110A can include a single output port 112 including outputs for both ultrasonic signal and light for delivery to the handheld device 120A. Additionally, the control line 126A can extend from the input device 124A to the integrated driver 110A. As such, the integrated driver unit 110A can be configured to deliver any one or any combination of ultrasonic signal, water, and light for delivery to the tip assembly 130A.

The integrated driver 110A can receive a control signal from the input 124A through the control line 126A. The driver 110A can be configured to use the signal from the control line 126A to control any one or any combination of delivery of sonic energy and/or light. Similarly, the control assembly 134A can be connected to the integrated driver 110A and can be used to control any one of or any combination of sonic energy and light delivered to the ultrasonic tip assembly 130A.

FIG. 3C is a schematic diagram illustrating the connections between the integrated driver unit 100A and the ultrasonic tip assembly 130A. As shown in FIG. 3C, the integrated driver 110A can include a light source 180, sonic energy source 182, and a water source 184. Additionally, the integrated driver 110A can include a light control connector 186o, a light energy connector 188o, a water supply connector 190o, and a sonic energy connector 192o.

The connector assembly 122A can include a like control line 126A, a light optical fiber 170, a water channel 172, and a sonic energy conduit 174. Additionally, the connector assembly 122A can include an input end 194 and an output end 196. The input end 194 can be configured to connect to the output port 112 of the integrated driver 110A. For example, the input end 194 can include corresponding connectors 186a, 188a, 192a, 190a. As such, the input end 194 of the connector assembly 122A can connect to the connector 112 with the connectors 186a, 188a, 192a, 190a, connecting with the connectors 186o, 188o, 190o, 192o, respectively.

Similarly, the output end 196 of the connector assembly 122A can include connectors 186b, 188b, 190b, and 192b. Additionally, the handheld piece 120A can include corresponding connectors 186c, 188c, 190c, and 192c. As such, the input end of the handheld piece 120A can connect to the output end 196 of the connector assembly 122A, with the connectors 186c, 188c, 190c, 192c connecting with the connectors 186b, 188b, 190b, 192b, respectively.

The connector 186c can provide electrical connection to the input device 124A for providing the signal to the light energy source 180.

The connector 186c can provide an optical connection to the ultrasonic scale or tip assembly 130A, described in more detail below.

The connector 190c can provide a connection for water from the water source 184 to the ultrasonic tip assembly 130A. Finally, the connector 192c can provide a fork connection and transfer of sonic energy from the sonic energy source 182 to a sonic actuator 194 within the handheld piece 120A.

The ultrasonic tip assembly 130A can include an optical connector 188d and a water connector 190d. As such, the ultrasonic tip assembly 130A can receive light energy from the light source 180 of the connector, 188d and water from the water source 184 through the water connector 190b. The various connecters described above can be in the form of any known connector, including butt connectors, male-female connectors, or other types of connectors well known in the art for various types of connecting functionalities.

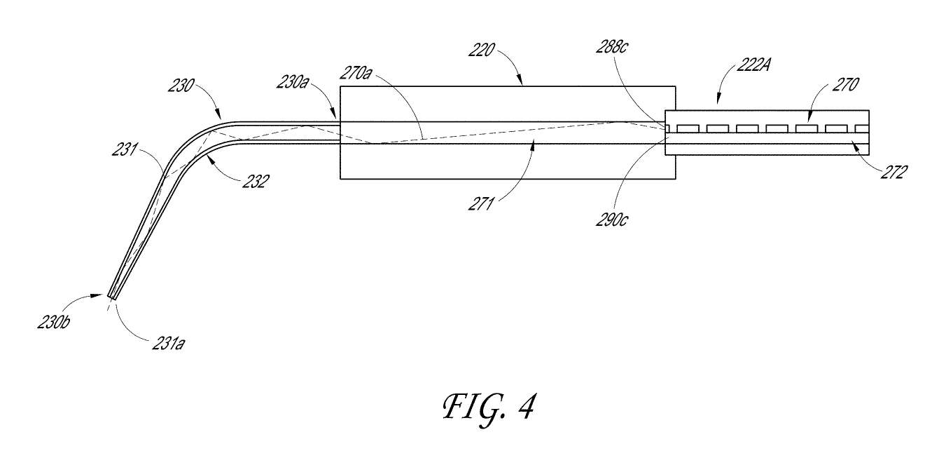

FIG. 4 illustrates a modification of the handheld piece 120, identified generally by the reference number 220. Parts, components, features, and functionality of the handheld piece assembly 220 are similar or the same as the handheld pieces 120, 120A described above, are identified generally with the same reference numerals except that “100” has been added thereto.

With reference to FIG. 4, handpiece 220 can be connectable to connector assembly 222A with connectors 288C for receiving light from the fiber 270 and the connector 290C for receiving water through a water channel 272 within the connector assembly 222A. The handheld piece 220 can include a central passage 271 configured to guide both light and water to the ultrasonic tip assembly 230. With such an embodiment, both light, such as laser light from the fiber 270 and water from the channel 272 are fed to the handheld piece 220 and then to the ultrasonic tip assembly 230. The inner surface of the passage 270 can be smooth with a high reflectivity sufficient to guide light, such as laser light, to the ultrasonic tip assembly 230 with sufficient efficiency for bacterial load reduction results.

In some embodiments, the proximal end 230a of the ultrasonic tip assembly 230 can be engaged to the distal end of the handheld piece 220 with any type of engagement configuration, such as a threaded engagement, butt connector, male-female connector, or any type of connector known in the art. Some prior art devices use threaded connections, and such a connection can be used in the embodiment of FIG. 4.

In some embodiments, the ultrasonic tip assembly 230 includes an internal passage 231 that is configured to guide both light and water to a distal end 230b of the ultrasonic tip assembly 230. The distal end 230b of the ultrasonic tip assembly 230 is configured to be pressed against patient anatomy, such as teeth and/or gums, for scaling in the manner well-known in the art. The distal end 230b, however, can include an aperture 231A configured to allow light and/or water to be discharged from the distal end 230B. Thus, as illustrated in FIG. 4, the light represented by the dashed line 270A is guided through the passage 271, and through the passage 231A, to the aperture 231A. Thus, during operation, both light and water can be discharged from the distal end 230b of the ultrasonic tip assembly 230.

Similarly to the passage 271, the passage 231 can include sufficient smoothness and reflectivity to guide light, such as laser light, to the aperture 231A with sufficient efficiency that the light discharged from the aperture 231A has sufficient intensity so as to provide desired bacterial reduction. For example, using a typical power output setting of a known laser curettage device, the passage 231 can have a 50% reflectivity or more and sufficiently guide laser light out of the tip assembly 230 for bacterial load reduction.

In some embodiments, as illustrated in FIG. 4, an internal dimension, such as a diameter, of the passage 231 can reduce gradually from the proximal end 230A to the distal end 230B. Such a gradually reducing inner dimension of the passage 231 can provide for more light to be delivered to the distal end 230B and discharged through the aperture 231A.

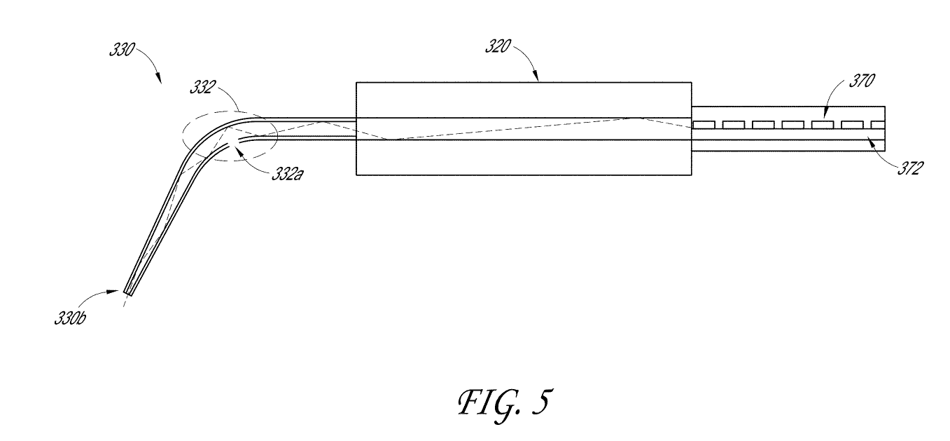

FIG. 5 illustrates yet another modification of the handheld piece 120, identified generally by the reference numeral 320. Parts, components, features and functionality of the handheld piece 320 that are similar or the same as the previously described embodiments of the handheld piece described above are identified with the same reference numeral, except that 200 has been added thereto.

As shown in FIG. 5, the ultrasonic scaler tip assembly 330 includes an additional aperture 332 positioned approximately in the concave portion 332. The aperture 332 is defined in the passage 331 and is configured to allow the discharge of water from the internal passage 331 at a position spaced away from the distal portion 330b.

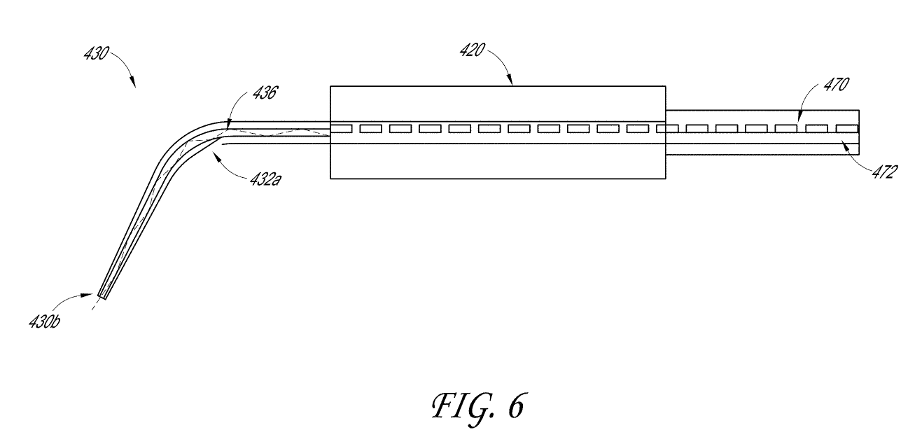

FIG. 6 illustrates yet another modification of the handheld piece 120, identified generally by the reference numeral 420. Parts, components, features, and functionality of the handheld piece 420 are identified with the same reference numerals used above with regard to the system 100, except that 300 has been added thereto.

As shown in FIG. 6, an optical fiber 436 is disposed in the tip assembly 430 to deliver laser light to the distal end 430b of the tip assembly 430. Using such an additional portion of optical fiber 436 in the tip assembly 430 can provide an optional additional advantage of improving light transmission efficiency as compared to using hollow passage, such as in the embodiments of FIGS. 4 and 5. Optionally, an opening 432a in the concave region of the insert can be configured to deliver water for cleaning purposes during dental procedures such as scaling. In some embodiments, the laser light from the laser fiber 470 is directly coupled into the optical fiber 436 in the insert 30.

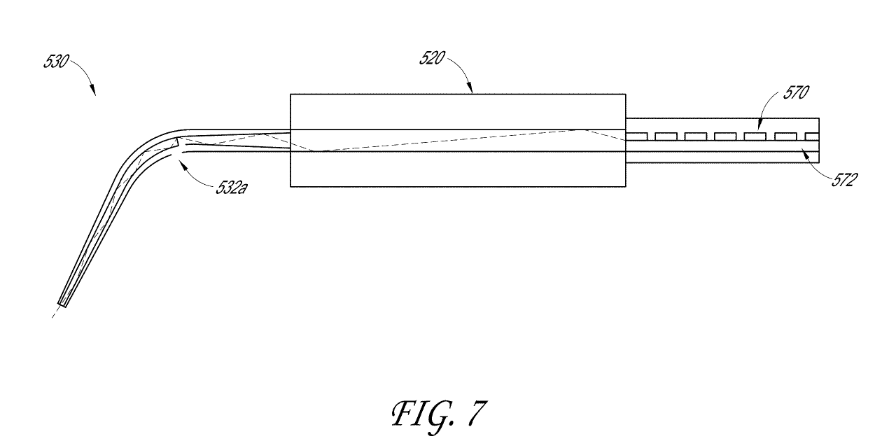

FIG. 7 illustrates yet another modification of the handheld piece 120, identified generally by the reference numeral 520. Parts, components, features, and functionality of the handheld piece 520 are identified with the same reference numerals used above with regard to the system 100, except that 400 has been added thereto. In this embodiment, the optical fiber 536 only extends from the tip to the opening 532a of the tip assembly 530.

The embodiments of FIGS. 4-7 have internal components to couple the laser light from the fiber 270, 370, 470, 570 through the corresponding handheld piece to the optical fiber 436, 536 or a hollow canal within the tip assembly. Any known art light coupling hardware or methods can be used inside the various embodiments if the handheld pieces to couple the laser light to the hollow canal or optical fiber in the tip assembly, for example, direct fiber contact in FIG. 6, hollow light pipe in FIGS. 4, 5 and 7. Other methods, such as the coupling lens can be used as well. All those coupling methods can be optimized using well known techniques to maximize the coupling efficiency for the current invention. The fibers for the lasers in embodiments in FIGS. 4-7 can be connected to different laser sources.

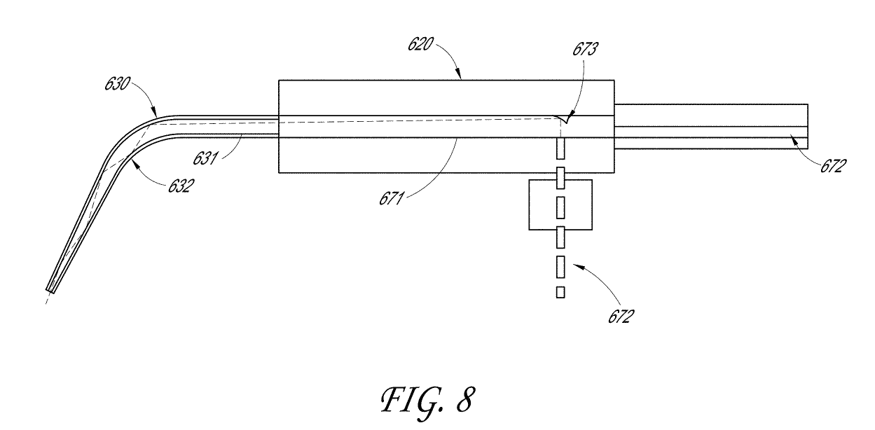

FIG. 8 illustrates yet another modification of the handheld piece 120, identified generally by the reference numeral 620. Parts, components, features, and functionality of the handheld piece 520 are identified with the same reference numerals used above with regard to the system 100, except that 600 has been added thereto.

As shown in FIG. 8, in some embodiments, light coupling can be accomplished a reflector 673 disposed in the passage 671 within the handheld piece 620. The light from the laser fiber 72 can be coupled into the hollow canal 631 of the tip assembly 630 directly by the concave reflector 673. In some embodiments, the light can be introduced into the passage 671 by a fiber 672 connected to the passage 671 at an oblique or perpendicular angle. By using the different fiber connecting to different laser sources, dental professionals can easily perform different procedures with different laser wavelengths.

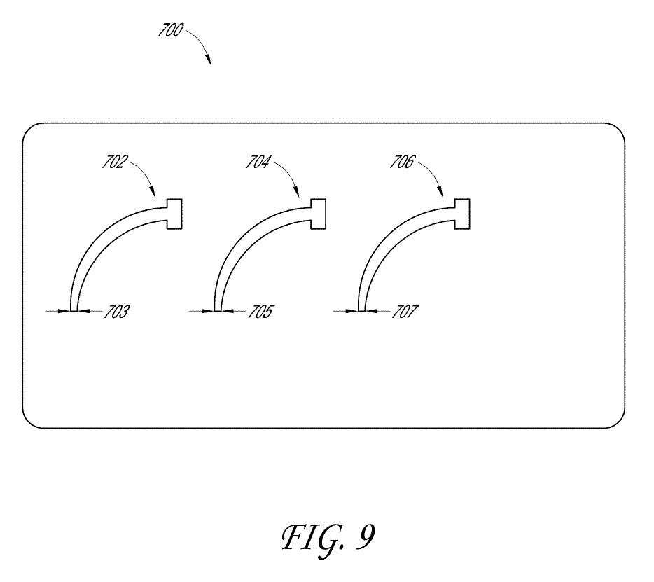

FIG. 9 is a schematic illustration of a kit 700 including a plurality of dental scaler tip members 702, 704, 706 having different widths 703, 705, 707 at their respective distal ends. Each of the dental scaler tip members 702, 704, 706 can have different colors, and as such can be considered as being color-coded according to the widths 703, 705, 707. In some embodiments, the different widths can be offset from each other by predetermined amounts such as 0.5 mm, 1 mm, 2 mm, or other magnitudes. The kit 700 can include any type of container for containing a plurality of dental scaler tip members.

These and other advantages of the present inventions will be apparent to those skilled in the art from the foregoing specification. Accordingly, it will be recognized by those skilled in the art that changes or modifications may be made to the above-described embodiments without departing from the broad inventive concepts of the inventions disclosed herein. It should therefore be understood that the inventions are not limited to the particular embodiments described herein, but are intended to include all changes and modifications that are within the scope and spirit of the inventions disclosed herein.

What is claimed is:

1. A dental scaler system, comprising:
an ultrasonic driver having an ultrasonic vibration signal output port, the ultrasonic driver configured to discharge an ultrasonic frequency vibration signal from the ultrasonic vibration signal output port;
a laser light source having a laser light output port; the laser light source configured to discharge laser light from the laser light output port;
a hand-piece housing having an outer surface configured to be graspable and manipulable with a user's hand, the hand-piece housing having an input assembly connected to the ultrasonic vibration signal output port so as to receive an ultrasonic vibration signal from the ultrasonic driver, the input assembly also connected to the laser light output port so as to receive laser light from the laser light source, the hand-piece also comprising a output assembly configured to output an ultrasonic vibration and laser light;
an ultrasonic scaler member having a proximal end and a distal end, the proximal end of the ultrasonic scaler member being connected to the output assembly of the handpiece housing, the ultrasonic scaler member comprising a light guide extending from a light guide input at the proximal end of the ultrasonic scaler member to a light guide output at the distal end of the ultrasonic scaler member, the light guide output configured to discharge laser light from the distal end of the ultrasonic scaler member; and
an ultrasonic transducer disposed in the hand-piece and in vibrational communication with the ultrasonic scaler member, the ultrasonic transducer configured to vibrate the ultrasonic scaler member at an ultrasonic frequency.

2. The dental scaler according to claim 1, the light guide is configured to receive laser light having a wavelength in the range of 0.4 μm to 3.0 μm.

3. The dental scaler according to claim 1, wherein the light guide comprises a hollow passage extending from the proximal end of the ultrasonic scaler member to the distal end of the ultrasonic scaler member, the light guide comprising an inner surface with high reflectivity.

4. The dental scaler according to claim 1, wherein the handpiece housing comprises a light coupling including a reflector connecting the input assembly with the output assembly.

5. The dental scaler according to claim 4, wherein the light coupling comprises a fiber coupler.

6. The dental scaler according to claim 1, wherein the ultrasonic scaler member includes a concave portion, and water outlet port being disposed in the concave portion.

7. The dental scaler according to claim 1, wherein the ultrasonic scaler member comprises a canal extending from the proximal end to the distal end of the ultrasonic scaler member, the canal configured to guide water from the proximal end to the distal end.

8. A dental scaler, comprising
a hand-piece housing having an outer surface configured to be graspable and manipulable with a user's hand;
an ultrasonic scaler member having a proximal end and a distal end, the proximal end of the ultrasonic scaler member being connected to the hand-piece housing, the proximal end of the ultrasonic scaler member including a light input portion and a light guide extending from the light input portion to a light output portion at a distal end of the ultrasonic scaler member, the light output portion being configured to discharge laser light from the distal end of the ultrasonic scaler member.

9. The dental scaler according claim 8 additionally comprising an ultrasonic transducer disposed in the hand-piece and in vibrational communication with the ultrasonic scaler member, the ultrasonic transducer configured to vibrate the ultrasonic scaler member at an ultrasonic frequency.

10. The dental scaler according to claim 8, in combination with an ultrasonic driver operationally connected to the ultrasonic scaler member and configured to transfer an ultrasonic frequency vibration signal to the ultrasonic scaler member.

11. The dental scaler according to claim 8, in combination with a laser light source operationally connected to the ultrasonic scaler member and configured to provide laser light to the ultrasonic scaler member.

12. The dental scaler according to claim 8 additionally comprising an input device disposed on an outer surface of the hand-piece housing configured to control discharge of light through the ultrasonic scaler member.

13. The dental scaler according to claim 8, wherein the light guide is configured to receive laser light having a wavelength in the range of 0.4 μm to 3.0 μm.

14. The dental scaler according to claim 8, wherein the light guide has an upstream end and a downstream end, the upstream end being larger than the downstream end.

15. The dental scaler according to claim 8, wherein the light guide has an inner diameter that gradually changes from a larger diameter at the upstream end to a smaller diameter at the downstream end.

16. The dental scaler according to claim 8, wherein the handpiece housing comprises a fiberoptic light coupling including a reflector, connecting the light input portion with the light output portion.

17. A dental scaler tip member comprising a proximal end and a distal end, the proximal end of the dental scaler member being configured to be connectable to an ultrasonic scaler hand-piece housing, the proximal end of the ultrasonic scaler member including a light input portion and a light guide extending from the light input portion to a light output portion at a distal end of the ultrasonic scaler member, the light output portion being configured to discharge laser light from the distal end of the ultrasonic scaler member.

18. The dental scaler according to claim 17, wherein the light guide has an inner surface with a reflectivity of at least 50%.

19. The dental scaler according to claim 17, wherein the light guide is configured to guide laser light having a wavelength in the range of 0.4 μm to 3.0 μm from the proximal end to the distal end of the dental scaler tip member.

20. The dental scaler according to claim 17, wherein the dental scaler tip member is configured to be vibrated at an ultrasonic frequency during a dental scaling procedure.

21. A dental scaler tip kip comprising at least first and second dental scaler tip members, each of the plurality of dental scaler tip members comprising a proximal end and a distal end, the proximal end of each dental scaler member being configured to be connectable to an ultrasonic scaler hand-piece housing, the distal end of each of the dental scaler tip members having a different dimension, each of the dental scaler tip members having a different color, and all of the plurality of dental scaler tip members being contained in a single container.
